(19) United States
(12) Patent Application Publication
(10) Pub. No.: US 2026/0070818 A1
(43) Pub. Date: Mar. 12, 2026

(54) METHOD FOR REMOVING PFAS WITH VARIOUS CHAIN LENGTHS IN A SINGLE SYSTEM

(71) Applicant: THE BOARD OF TRUSTEES OF THE UNIVERSITY OF ILLINOIS, Urbana, IL (US)

(72) Inventors: Xiao SU, Champaign, IL (US); Nayeong KIM, Champaign, IL (US); Johannes ELBERT, Urbana, IL (US)

(21) Appl. No.: 19/323,653

(22) Filed: Sep. 9, 2025

Related U.S. Application Data
(60) Provisional application No. 63/692,701, filed on Sep. 9, 2024.

(51) Int. Cl. C02F 1/469; B01D 61/02; B01D 61/42; B01D 69/02; C02F 1/461; C02F 1/467; C02F 101/34; C02F 101/36

(52) U.S. Cl. CPC C02F 1/4693; B01D 61/027; B01D 61/422; B01D 69/02; C02F 1/46109; C02F 1/4672; B01D 2311/08; B01D 2325/34; C02F 2001/46147; C02F 2101/34; C02F 2101/36

(57) ABSTRACT

A method for removing PFAS from a feed solution includes: flowing a feed solution comprising PFAS of varying chain lengths through a feed channel; applying a voltage to a first electrode and a second electrode in a redox channel separated from the feed channel by a first SEM, the first electrode becoming positively charged and the second electrode becoming negatively charged, wherein the PFAS in the feed solution transfer through the first SEM into the redox channel toward the first electrode; and separating PFAS based on chain length, wherein long-chain PFAS adhere to the first electrode through hydrophobic and electrostatic interactions, and short-chain to ultra-short chain PFAS migrate toward the second electrode in the redox channel and pass through a second SEM into an accumulating channel, thereby creating a PFAS-concentrated solution in the accumulating channel.

### RELATED APPLICATION

The present patent document claims the benefit of priority under 35 U.S.C. 119(e) to U.S. Provisional Patent Application 63/692,701, which was filed on Sep. 9, 2024, and is hereby incorporated by reference in its entirety.

### STATEMENT OF FEDERALLY FUNDED RESEARCH OR DEVELOPMENT

This invention was made with government support under grant no. 2329449 awarded by the National Science Foundation. The government has certain rights in the invention.

### TECHNICAL FIELD

The present disclosure is related generally to electrodialysis, and more specifically to methods and systems for removing per-and polyfluoroalkyl substances (PFAS) from a feed solution and systems for defluorination of PFAS.

### BACKGROUND

Per- and polyfluoroalkyl substances (PFAS) are major emerging contaminants to be tackled in clean water production and environmental remediation. A key challenge in PFAS remediation is the structural and chemical diversity of PFAS, ranging from ultra-short to long-chain compounds. Recent work has focused mostly on a subset of PFAS (e.g., either long-chain or short-chain), with relatively few studies targeting simultaneous removal across the entire chain-length range. As a result, conventional electrodialysis system typically removes ultra-short-to long-chain PFAS through a series of separate processing steps. Consequently, the removal of PFAS with varying chain lengths increase operational complexity, capital costs, and energy consumption.

### BRIEF DESCRIPTION OF THE DRAWINGS

FIG. 1A shows a schematic illustration of a redox-polymer electrodialysis (ED) system for PFAS removal via electrosorption and ion migration in tandem with desalination.

FIG. 1B shows a schematic illustration of a system for defluorination of PFAS comprising a redox-polymer ED system and an electrochemical oxidation system.

FIG. 2 shows a reaction scheme for synthesizing a water-soluble redox polymer, P(TMA-co-TMPMA-co-METAC), by free-radical copolymerization and chemical oxidation.

FIG. 3A shows TFA (C2) concentration changes (mM) over time in a feed channel (FC), an accumulating channel (AC), and a redox channel (RC) of a redox-polymer ED system with size exclusion membranes (SEMs).

FIG. 3B shows TFA (C2) concentration changes (mM) over time in a FC, an AC, and a RC of a redox-polymer ED system with anion exchange membranes (AEMs).

FIG. 4A shows TFA (C2) removal efficiencies (%) of a redox-polymer ED system after 7-hour operation, at initial TFA (C2) concentrations of 1 μM, 10 μM, 100 μM, and 1,000μM with 10 mM Cl⁻.

FIG. 4B shows FPrA (C3) removal efficiencies (%) of a redox-polymer ED system after 7-hour operation, at initial FPrA (C3) concentrations of 1 μM, 10 μM, 100 μM, and 1,000 μM with 10 mM Cl⁻.

FIG. 5A shows PFAS and Cl⁻ removal efficiencies (%) of a redox-polymer ED system, in a mixture solution of 10 mM Cl⁻, 10 μM PFPrA (C3), 10 μM PFBA (C4), 10 μM PFHxA (C6), and 10 μM PFOA (C8).

FIG. 5B shows PFAS and Cl⁻ removal efficiencies (%) of a conventional ED system, in a mixture solution of 10 mM Cl⁻, 10 μM PFPrA (C3), 10 μM PFBA (C4), 10 μM PFHxA (C6), and 10 μM PFOA (C8).

FIG. 6 shows electrosorption removal efficiencies (%) of a redox-polymer ED system, at initial concentrations of 1 mM TFA (C2), 1 mM PFPrA (C3), 1 mM PFBA (C4), 1 mM PFHxA (C6), and 1 mM PFOA (C8) in a FC.

FIG. 7A shows concentration changes (%) of Cl⁻ and TFA (C2) in a FC over 7-hour period, at an initial concentration of 10 mM Cl⁻ and 1 μM TFA (C2).

FIG. 7B shows concentration changes (%) of Cl⁻ and TFA (C2) in a FC over 7-hour period, at an initial concentration of 10 mM Cl⁻ and 100 μM TFA (C2).

FIG. 7C shows concentration changes (%) of Cl⁻ and TFA (C2) in a FC over 7-hour period, at an initial concentration of 10 mM Cl⁻ and 1 mM TFA (C2).

FIG. 8A shows concentration changes (%) of Cl⁻ and PFPrA (C3) in a FC over 7-hour period, at an initial concentration of 10 mM Cl⁻ and 1 μM PFPrA (C3).

FIG. 8B shows concentration changes (%) of Cl⁻ and PFPrA (C3) in a FC over 7-hour period, at an initial concentration of 10 mM Cl⁻ and 100 μM PFPrA (C3).

FIG. 8C shows concentration changes (%) of Cl⁻ and PFPrA (C3) in a FC over 7-hour period, at an initial concentration of 10 mM Cl⁻ and 1 mM PFPrA (C3).

FIG. 9A shows distribution (%) of Cl⁻, TFA (C2) and PFBA (C4) after 7-h our operation of a redox-polymer ED system, at an initial concentration of 2 mM for each species in the feed solution.

FIG. 9B shows distribution (%) of Cl⁻, TFA (C2), PFBA (C4), and PFHxA (C6) after 7-hour operation of a redox-polymer ED system, at an initial concentration of 2 mM for each species in the feed solution.

FIG. 9C shows distribution (%) of Cl⁻, TFA (C2), PFBA (C4), PFHxA (C6), and PFOA (C8) after 7-hour operation of a redox-polymer ED system, at an initial concentration of 2 mM for each species in the feed solution

FIG. 10A shows PFAS degradation efficiencies (%) and a defluorination efficiencies (%) of TFA (C2) and PFPrA (C3) (removal driven by migration) and PFHxA (C6) (removal driven by electrosorption).

FIG. 10B shows defluorination kinetics (%) of TFA (C2), PFPrA (C6), and PFHxA (C6) over 8 hours of the oxidation process.

### DETAILED DESCRIPTION

Described in this disclosure are a method for removing PFAS from ultra-short all the way to long-chain PFAS within a single redox-polymer ED system. A redox-polymer ED system for removing PFAS from a feed solution and a system for defluorination of PFAS are also described.

A method for removing PFAS from a feed solution in this disclosure removes a range of structural diverse PFAS, especially highly challenging ultra-short-chain PFAS, as well as short-chain PFAS and long-chain PFAS, in tandem with desalination. The method employs two mechanisms: (i) electrodialysis for the up-concentration of ultra-short-and short-chain PFAS (PFAS with chain lengths ≤C4) and (ii) electrosorption for removing long-chain PFAS (PFAS with chain lengths ≥C6). The ultra-short-chain PFAS may include trifluoroacetic acid (TFA, C2) or perfluoropropanoic acid (PFPrA, C3); the short-chain PFAS may include perfluorobutanoic acid (PFBA, C4); and the long-chain PFAS may include perfluorohexanoic acid (PFHxA, C6) or perfluorooctanoic acid (PFOA, C8). As different chain lengths of PFAS move from a FC (where a feed solution circulates) to a redox channel (where reversible redox reactions occur), a positively charged electrode in the redox channel selectively captures long-chain PFAS through hydrophobic and electrostatic interactions. Simultaneously, ultra-short to short-chain PFAS migrate to an accumulating channel, where they become concentrated. That is, long-chain PFAS are predominantly removed via electrosorption on to the positively charged electrode, while short-chain to ultra-short chain PFAS are predominantly removed via ion migration.

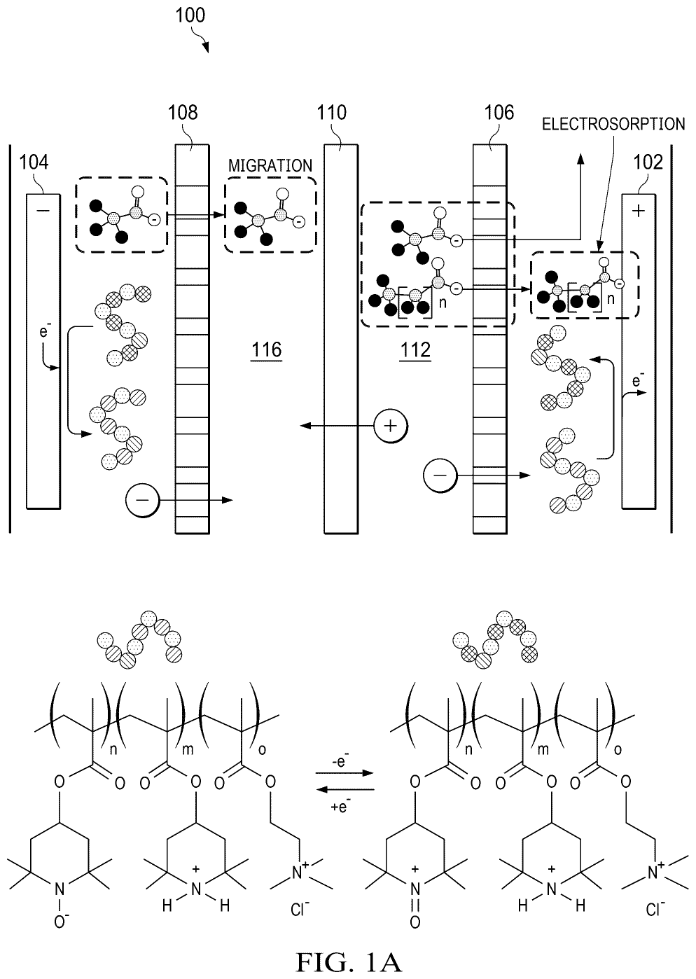

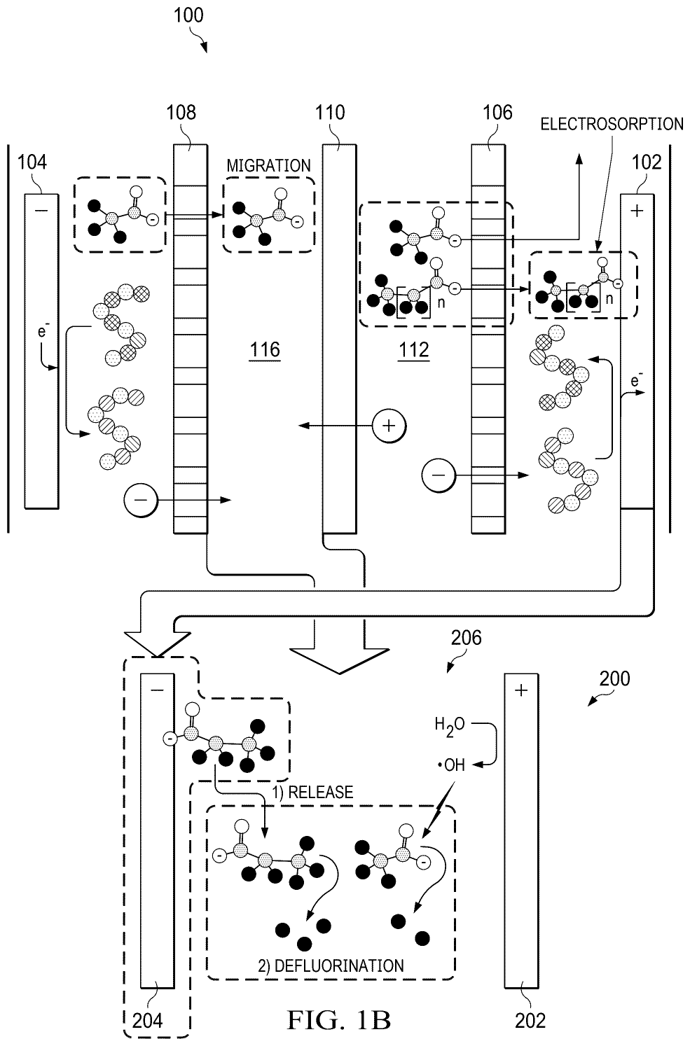

Referring to FIG. 1A, the redox-polymer ED system 100 includes a first electrode 102; a second electrode 104 positioned in opposition to the first electrode 102; a first size exclusion membrane (SEM) 106 and a second SEM 108 positioned between the first and second electrodes 102,104; and a cation exchange membrane (CEM) 110 positioned between the first and second SEMs 106,108.

The CEM 110 defines a feed channel (FC) 112 and an accumulating channel (AC) 116 between the first and second SEMs 106,108. The FC 112 extends between the CEM 110 and the first SEM 106 and is configured for flow of a feed solution (i.e., water to be treated). The AC 116 extends between the CEM 110 and the second SEM 108 and is configured for collection of ionic species (e.g., PFAS, Na⁺, K⁺, Mg²⁺, Ca²⁺, Cl⁻, SO₂⁴⁻) removed from the water. The CEM 110 controls the direction of ion migration. Anionic species such as PFAS in the FC 112 are drawn through the first SEM 106 adjacent to the FC 112 and into a redox channel (RC) 114 prior to entering the AC 116. Inorganic cations in the FC 112 move to AC 116 through the CEM 110.

The first SEM 106 separates a RC 114 from the FC 112, and the second SEM 108 separates the RC 114 from the AC 116. The SEMs 106,108 may be permeable to the ionic species but impermeable to the redox polymer. For example, the SEMs 106,108 may comprise nanofiltration (NF) membrane. For example, a non-functionalized cellulose-based NF with a 1.0 kDa molecular-weight cut-off (MWCO) may be employed. The SEMs 106,108 may have two distinct molecular weight cut-offs. The redox-polymer ED system 100 replaces expensive and less durable AEMs with affordable SEMs, thereby avoiding membrane fouling by redox materials and organic contaminants which is associated with traditional AEMs.

The RC 114 is configured for continuous circulation of the redox solution; for example, the RC 114 may form a closed loop. The RC 114 contains the first and second electrodes 102,104. For example, the first and/or second electrodes 102,104 may be activated carbon cloth (ACC) electrodes.

The method is now described, also in reference to FIG. 1A. Upon the application of a voltage, the first electrode 102 becomes positively charged, and the second electrode 104 becomes negatively charged. A feed solution comprising PFAS of varying chain lengths are flowed through the FC 112, and the PFAS in the feed solution transfer through the first SEM 106 into the RC 114 toward the first electrode 102. The PFAS are separated based on chain length, wherein the long-chain PFAS adhere to the first electrode 102 through hydrophobic and electrostatic interactions, and short-chain to ultra-short chain PFAS migrate toward the second electrode 104 in the RC 114 and pass through the second SEM 104 into the AC 116, thereby creating a PFAS-concentrated solution in the AC 116.

The first and second electrodes 102,104 facilitate rapid electron transfer to water-soluble redox polymers dissolved in the redox solution as an electrolyte, while efficiently electrosorbing long-chain PFAS removed from a feed solution. When the redox polymer circulates through the RC, it undergoes reversible oxidation and reduction processes at the same E_{1/2}, leading to lower energy consumption compared to conventional ED. Additionally, the macromolecular structure of redox polymer ensures effective retention at the SEMs, and controls the direction of desalination and PFAS removal while preventing membrane fouling. Upon the applied voltage, both inorganic anions and PFAS undergo ion migration facilitated by redox reactions and an electric field, crossing over the first SEM, whereas cations pass through the CEM. Subsequently, the first electrode electroadsorbs hydrophobic long-chain PFAS, while ultra-short to short-chain PFAS cross over the second SEM to be concentrated in the AC.

Referring now to FIG. 1B, the method may further include flowing the PFAS-concentrated solution into an electrochemical oxidation system 200 comprising two electrodes 202,204 that are oppositely charged during operation.

Upon application of positive and negative voltages to each electrode 202,204, the shorter-chain PFAS present in the PFAS-concentrated solution may be defluorinated.

In embodiments, the method may further include obtaining, after separating PFAS based on chain length, the first electrode 102 with adhered PFAS; placing the first electrode 102 with adhered PFAS into an electrochemical oxidation system 200; and applying a negative voltage to the first electrode 102,204 to facilitate release of the adhered PFAS.

In embodiments, the method may further include flowing the PFAS-concentrated solution from the accumulating channel 116 into an electrochemical oxidation system 200 comprising the first electrode 102,204 with adhered PFAS and another electrode 202, wherein the adhered PFAS comprises the long-chain PFAS; and applying a negative voltage to the first electrode 102,204 and a positive voltage to the other electrode 202, wherein the adhered PFAS is released from the first electrode 102,204, and the long-chain and short-chain to ultra-short chain PFAS in the solution are defluorinated.

The method may eliminate greater than about 80% of PFAS from the feed solution and additionally desalinate the feed solution to a potable water level during PFAS removal process.

Various redox polymers can be incorporated into the redox-polymer ED system 100 for water remediation with lower energy consumption, capital, and operating costs. For example, ferrocene-based polymers (e.g., P(FPMAm-co-METAC)), TEMPO-based polymers (e.g., P(TEMPO-co-METAC)), or viologen-based polymers, or any other redox-active species, copolymerized with a water-soluble monomer (e.g., METAC and PEGMA), can be employed as a redox polymer. The redox polymer may include a redox-active moiety and a water-soluble moiety and may be designed to balance a high content of redox-active moiety with high water-soluble moiety. The redox polymer may be a biopolymer or a terpolymer. A redox polymer may have a molecular weight above the molecular weight cut-off of the SEMs 106,108 to avoid membrane crossover. An average molecular weight (Mn) of a redox polymer may also or alternatively be less than 10,000 g/mol, less than 7,000 g/mol, or less than 5,000 g/mol. For example, an average molecular weight (Mn) of a redox polymer may be in a range from about 1,000 g/mol to about 5,000 g/mol.

Control of the co-monomer ratio, types of water-soluble comonomer, and the molecular weight or chain length of polymer allows adjustment of the electrochemical kinetics and diffusion rates of the redox polymer, which are not easily controlled when using redox species.

In embodiments, the redox polymer may be poly(2,2,6,6-tetramethyl-1-piperidinyloxymethacrylate-co-2,2,6,6-tetramethyl-1-piperidylmethacrylate-co-[2-(methacryloyloxy)ethyl]trimethyl-ammonium chloride) P(TMA-co-TMPMA-co-METAC). It is demonstrated that using P(TMA-co-TMPMA-co-METAC) in the redox-polymer ED system 100 enables effective PFAS removal owing to its unique physicochemical and electrochemical properties in comparison to other water-soluble redox-active polymers, such as ferrocene-based redox-active polymers.

Redox-active units, containing ferrocene-and cobaltocenium, have demonstrated highly effective electrosorption, especially for long-chain PFAS molecules. Consequently, integrating them into the redox-polymer ED system poses a challenge, as a subsequent desorption/defluorination step is necessary to release the bound PFAS before the polymer recycling. In this regard, the redox-active moiety, TMA, facilitates redox reaction without direct interactions with PFAS, enhancing the up-concentration of ultra-short-to short-chain PFAS and promoting the electrosorption of long-chain PFAS on the electrodes.

The redox-polymer ED system 100 may remove PFAS in real-source water scenarios, including water matrices with 10,000 times higher salt concentrations.

The redox-polymer ED system 100 may also remove a wide range of inorganic ions such as Na⁺, K⁺, Mg²⁺, Ca²⁺, Cl⁻, NO₃—, PO₄³⁻ and SO₂⁴⁻, charged organic contaminants, and biomolecules from the municipal wastewater, industrial downstream, brine, or seawater. To make the system more practical for water treatment and eventual industrial deployment, the overall water treatment rate can be improved by increasing the concentration of redox species with stacked electrodes and arranging additional channels (FC and AC) in series.

Referring to FIG. 1B, the redox-polymer ED system 100 may be coupled with a mineralization system for PFAS defluorination process. For example, the mineralization system may be an electrochemical oxidation system 200 comprising two electrodes 202,204 that are oppositely charged during operation. The electrochemical oxidation system 200 is configured to receive a concentrated solution of short-chain to ultra-short chain PFAS from the AC 116 of the redox-polymer ED system 100. The first electrode 102, on which long-chain PFAS adheres following the redox-polymer ED, may be employed as the negatively charged electrode 204 in the electrochemical oxidation system 200 during operation. The electrodes 202,204 may be boron-doped diamond electrode (BDD). Through the defluorination process, short-chain to ultra-short chain PFAS in the concentrated solution and long-chain PFAS adhered on the electrode 204 can be electrochemically mineralized with defluorination performance between 76-100%. The mineralization process is not limited to the electrochemical oxidation process but can be generalized to various oxidation methods including but not limited to photochemical/electrochemical oxidation, plasma-based methods, and ultrasonic irradiation.

Without wishing to be bound by any particular theory, there can be discussion herein of beliefs or understandings of underlying principles or mechanisms relating to embodiments of the disclosure. It is recognized that regardless of the ultimate correctness of any explanation or hypothesis, an embodiment of the disclosure can nonetheless be operative and useful.

### EXAMPLES

### Example 1—Preparation of Redox-polymer ED System

### 1. Design of Water-Soluble Redox-Polymer, P(TMA-co-TMPMA-co-METAC)

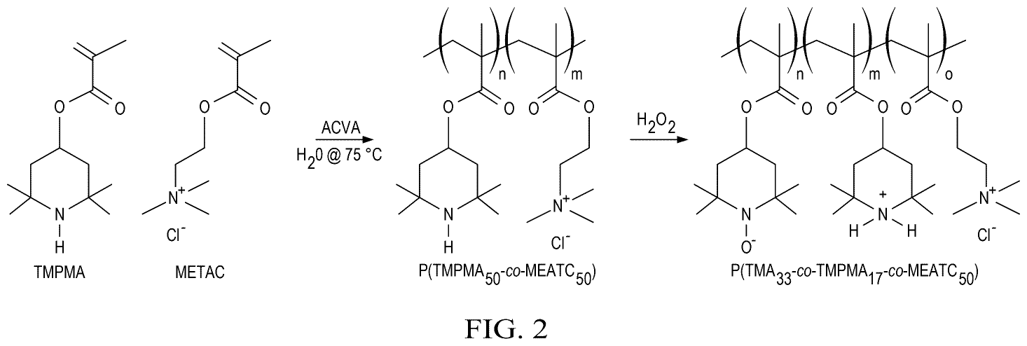

Referring to FIG. 2, the water-soluble redox-active terpolymer, P(TMA-co-TMPMA-co-METAC) to be used for the subsequent experiments, was synthesized through two steps. First, P(TMPMA-co-METAC) was synthesized through free-radical polymerization. 2,2,6,6-Tetramethyl-4-piperidyl methacrylate (TMPMA, 750 mM), [2-(methacryloyloxy)ethyl]trimethyl-ammonium chloride (METAC, 750 mM), and 2-mercaptoethanol (16 mol %) were dissolved in diluted hydrochloric acid solution (the stock HCl was diluted by a factor of 16). The mixture was degassed with argon for 60 min and 4,4′-azo-bis-(4-cyanovaleric acid) (ACVA, 10 mol %) was added before heating the mixture at 75° C. overnight. The solution was then cooled down to room temperature.

Next, the sodium hydroxide solution (10 wt %) mixed with hydrogen peroxide (150 mol %), sodium tungstate (1.3 mol %), ethylenediaminetetraacetic acid (EDTA, 0.5 mol %) were added to oxidize TMPMA to 2,2,6,6-tetramethyl-1-piperidinyloxy methacrylate (TMA) and prepare terpolymer, P(TMA-co-TMPMA-co-METAC). To prevent potential crossover within SEM (MWCO of 1.0 kDa) during the experiment, the polymer was dialyzed using a dialysis membrane with a molecular weight cut-off (MWCO) of 3.5 kDa against water twice and then MeOH once. The polymer was then precipitated in acetone, and centrifuged. The centrifuged polymer was dried under vacuum conditions at 60° C., with a 46% yield of P(TMA-co-TMPMA-co-METAC). The goal was to maximize the molar ratio of TMA within the terpolymer to enhance overall charge transfer reactions within the terpolymer without using an excessively large amount of the oxidizing agenSt. Consequently, with the oxidizing agent of 1.5 eq. H₂O₂, over 66% of TMPMA was converted into the redox-active moiety, TMA. The unreacted TMPMA moiety (17 mol % in terpolymer) enhances the overall solubility of the polymer as it becomes protonated in neutral solution (pKₐ of TMPMA: 11.28), along with the METAC which provides water solubility to the polymer.

### 2. Terpolymer Composition and Average Molecular Weight (Mn)

To calculate terpolymer composition, the ratio between TMPMA and METAC in P(TMPMA-co-METAC) was first calculated through ¹H-NMR (500 MHz, dMeOH, δ): 5.0-5.3 (1 H from the tertiary carbon of the piperidyl) and 3.7-3.9 and 4.3-4.7 (2 Hs, methylene group from METAC). NMR sample was prepared with 10 mg of polymer in 500 μL dMeOH solvent. Then, the ratio between TMPMA and TMA was calculated through UV-vis analysis (Cary 60, Agilent Technology). TEMPO dissolved in MeOH was used as a reference (3-33 μM) for TMA. The synthesized polymers (8-12 mg) were dissolved in MeOH to determine the concentration of TMA in the terpolymer. The molar ratios of the terpolymer were identified to be P(TMA₃₃-TMPMA17-METAC₅₀) with an average molecular weight of Mn of 2,260 g/mol measured by gel permeation chromatography (GPC).

### 3. Reversibility

To confirm the reversibility of the P(TMA₃₃-TMPMA₁₇-METAC₅₀), cyclic voltammetry (CV) was performed at varying scan rates of 5, 10, 30, 50, 75, and 100 mV/s. A three-electrode system with pt wires as working and counter electrodes and Ag/AgCl as a reference was used with a 5 mL solution of 30 mM P(TMA₃₃-TMPMA₁₇-METAC₅₀) and 100 mM NaCl. CV was IR compensated for the precise Randle-Sevic plotting. CV characterization at varying scan rates (5-100 mV/s) revealed remarkable reversibility of TMA at the E_{1/2} of 0.628 V.

### 4. Binding Affinity Towards PFAS

To investigate the sorption affinity between water-soluble redox polymer and PFAS, the binding constant (Kₐ) between the TMPMA and METAC moieties and PFAS (TFA and PFHxA) was calculated using ¹⁹F-NMR spectroscopic titrations. The calculated Kₐ values for TMPMA towards TFA and PFHxA are 9.74 M⁻¹ and 40.2 M⁻¹, respectively, and for METAC, they are 8.9 M⁻¹ and 38.1 M⁻¹, respectively. Since Kₐ values for strong binding typically exceed 10⁴ M⁻¹, these results confirm that the TMPMA and METAC moieties in P(TMA-co-TMPMA-co-METAC), along with TMA, are unlikely to participate in PFAS adsorption. Furthermore, TMA and TMPMA are less hydrophobic than ferrocene, allowing for higher molar ratios of redox-active moieties within the polymer. Consequently, this higher molar ratio of TMA promotes a greater extent of redox reactions at equivalent polymer concentrations compared to other water-soluble polymers.

### 5. Preparation of a Redox-Polymer ED System

The redox-polymer ED systems for the following experiments were fabricated to include a RC (4×4×0.2 cm³), as well as customized FC (4×4×0.3 cm³) and ACs (4×4×0.3 cm³). In the RC, Ti-mesh was used as current collectors, and ACC (3.0×3.0 cm² with a weight of 200-250 mg) were used as both cathodic and anodic electrodes. As illustrated in FIG. 1A, these channels were arranged in the sequence of RC (cathodic chamber)-SEM-AC-CEM-FC-SEM-RC (anodic chamber). Based on the arrangement sequence, CEM and SEMs (4.0×4.0 cm²) were positioned between the channels, each having an active surface area of 3.5×3.5 cm². Cellulose-based dialysis SEMs (Spectra/Por 3) with 1.0 kDa were used as SEMs for redox-polymer ED systems. CEMs (CMVN, Selemion) and AEMs (AMVN, Selemion) were used for redox-polymer ED systems and control systems, respectively. Unless specified, the system was operated at the flow rate of 10 mL/min for all FC, AC, and RC within a closed loop.

### Example 2—Membrane Fouling Test

To examine of membrane fouling, a membrane adsorption test using 1 mM TFA or the mixture of ultra-short-to long-chain PFAS (1 mM of TFA, PFPrA, PFBA, PFHxA, and PFOA), on AEM, CEM, and SEM was performed. Each membrane (2.0×2.0 cm²) was immersed in 10 mL of target PFAS solutions containing 10 mM NaCl for 24 hours to ensure saturated adsorption of PFAS on membranes.

In the presence of 1 mM TFA, more than 80% of the TFA was undetectable in the solution following the immersion of AEM into the TFA solution. Notable C═O and C—F peak formations on the FTIR spectrum indicate the presence of TFA on the AEM membrane surface. Moreover, energy-dispersive X-ray spectroscopy (EDS) mappings show a distinct fluoride presence, while scanning electron microscopy images reveal increased roughness and non-uniformity compared to pristine AEM, indicating alterations in surface morphology and the formation of aggregates.

For SEMs and CEM, on the other hand, there were negligible changes observed in the concentration of TFA, the FTIR spectrum, the surface morphology in scanning electron microscopy images, and the fluoride content in EDS mappings. This comprehensive analysis supports the successful removal of TFA without any fouling formation on the SEMs and CEM in the redox-polymer ED system.

The C═O and C—F peak formations on AEM became more distinct in the presence of 1 mM of TFA, PFPrA, PFBA, PFHxA, and PFOA as both concentrations of PFHxA and PFOA decrease by 30% and 80%, respectively. Furthermore, the X-ray photoelectron spectroscopy (XPS) spectrum reveals significant CFx peaks in both the C1s and F1s spectra following the immersion of AEM in PFAS solutions. Notable changes in the surface roughness and fluoride content were also observed on scanning electron microscopy images and EDS mappings, respectively. The irreversible adsorption observed on the AEM is attributed to the presence of the quaternary ammonium functional group, recognized for its strong affinity towards PFAS. In fact, this quaternary ammonium group has been demonstrated to be an effective candidate for ion-exchange resin materials for removing PFAS of various chain lengths, including PFBS, PFHxA, and PFOA. Due to its irreversible PFAS adsorption, AEM suffers performance deterioration, encountering 1.9-fold and 1.3-fold increases in charge-transfer (R_{ct}) and system resistances (Rₛ), respectively.

For SEMs and CEM, on the other hand, since both the cellulose-based SEMs and CEM do not contain cationic groups, they exhibit a low propensity to interact with anionic fluorinated compounds. Through various surface characterization techniques, including XPS, SEM, and EDS, no notable indications of PFAS adsorption were observed for the SEMs. Moreover, both charge transfer and membrane resistance remained unchanged after the immersion in the PFAS solution, highlighting the remarkable durability of SEMs against fluorinated organic compounds. Similar to SEM, CEM exhibited no membrane fouling when exposed to a broad range of PFAS, including ultra-short-to long-chain PFAS.

### Example 3—Performance of Redox-Polymer ED for the Removal of Ultra-Short Chain PFAS

The removal efficiency (%) of TFA (C2), the shortest PFAS compound, was evaluated using a redox-polymer ED system with SEMs and a redox-ED system with AEMs, respectively. To access its maximum performance of PFAS removal, redox polymer ED with an excess amount of TFA (1 mM) along with 10 mM NaCl in the FC was performed. Additionally, concentration distributions across the FC, AC, and RC were analysed to investigate any irreversible losses stemming from membrane fouling in both redox-polymer ED with SEMs and redox-ED with AEMs.

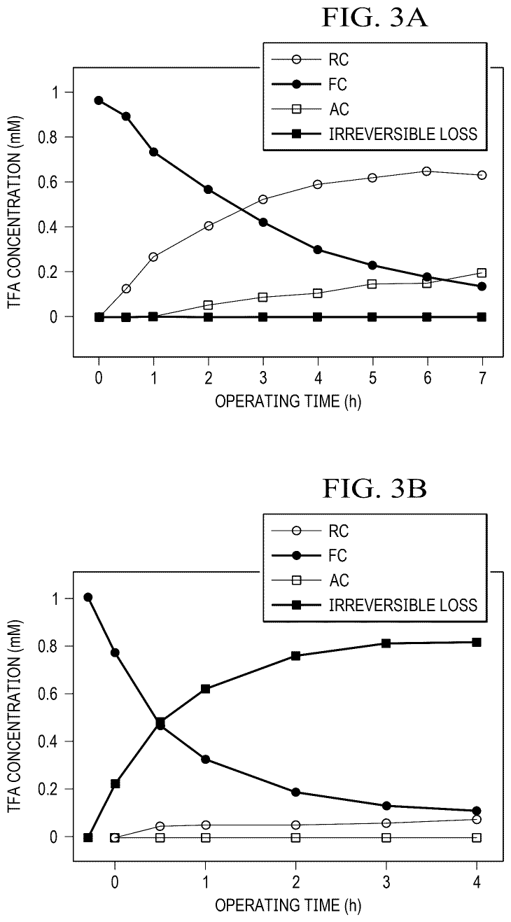

The redox-polymer ED system with SEMs exhibited over 86% TFA removal (FIG. 3A), accompanied by an 82% reduction in conductivity. With a final conductivity of 240 μS, the salt removal has reached levels within the potable water range (<500 μS/cm), demonstrating effective desalination along with the PFAS removal in a single process. In comparison to the redox-ED system with AEMs, redox polymer ED with SEMs also exhibited a 53% enhancement in salt removal kinetics, achieving potable water-level conductivity within 1.8 hours. The faster ion removal rate in the redox polymer ED could be attributed to the physicochemical properties of SEMs (e.g., large pore size), showing a 54% lower membrane resistance in comparison to the AEM, along with its ability to withstand membrane fouling from organic species. Moreover, the TFA concentration profiles across the FC, AC, and RC supported the negligible loss of removed TFA onto the membrane (<3%) due to membrane fouling. The kinetic profiles exhibited that 74% and 23% of the removed TFA were present in the RC and AC, respectively.

Fourier transform infrared spectroscopy (FTIR) analysis of SEMs was conducted to assess the adsorption of TFA on the SEMs. Given that the SEM comprises cellulose, distinct cellulose peaks appear in the pristine FTIR spectrum, notably the C—OH stretching (1015 cm⁻¹), C—O—C stretching of pyranose rings (1100 cm⁻¹), and O—H stretching (3350 cm⁻¹). After conducting 7-hour redox-ED experiments, the membranes using FTIR were analyzed and found no notable peak developments corresponding to TFA, such as the C—F peak (1200 cm⁻¹), nor any significant changes in the C═O peak. This spectroscopic analysis aligns with the mass balance calculated in the concentration profiles, emphasizing that the removal of PFAS in the redox-polymer ED system relies on PFAS migration rather than their irreversible binding to the membranes.

By contrast, while the redox-ED with AEMs achieved similar capability in removing TFA (89% TFA removal, FIG. 3B) and desalination (65% reduction in conductivity), it experienced irreversible adsorption of TFA on AEM, resulting in the loss of over 80% of the initial TFA. Notably, more than 23% of TFA was already fouled on the membrane within 10 minutes before applying voltage, indicating that the membrane fouling primarily stems from the charge interaction between the functional group of the AEM, the quaternary ammonium group, and the carboxylate on the TFA.

FTIR analysis of AEMs revealed distinct peaks attributed to C—F and C≡O from TFA after the redox-ED experiments, along with a C≡N peak from ferri-/ferrocyanide, confirming membrane fouling caused by PFAS and redox species.

The irreversible adsorption observed on the AEM may be attributed to the presence of the quaternary ammonium functional group, recognized for its strong affinity towards PFAS. In fact, this quaternary ammonium group has been demonstrated to be an effective candidate for ion-exchange resin materials for removing PFAS of various chain lengths, including PFBS, PFHxA, and PFOA. Due to its irreversible PFAS adsorption, AEM suffers performance deterioration, encountering 1.9-fold and 1.3-fold increases in charge-transfer (R_{ct}) and system resistances (Rₛ), respectively.

For the redox-ED with SEMs, in the presence of 1 mM of TFA, PFPrA, PFBA, PFHxA, and PFOA, since both the cellulose-based SEM and CEM do not contain cationic groups, they exhibit a low propensity to interact with anionic fluorinated compounds. Through various surface characterization techniques, including XPS, SEM, and EDS, no notable indications of PFAS adsorption were observed for the SEMs. Moreover, both charge transfer and membrane resistance remained unchanged after the immersion in the PFAS solution, highlighting the remarkable durability of SEMs against fluorinated organic compounds. Similar to SEMs, CEM exhibited no membrane fouling when exposed to a broad range of PFAS, including ultra-short-to long-chain PFAS.

Overall, the redox-polymer ED system with SEMs effectively addresses the limitation found in AEM-involved systems for PFAS removal, while achieving desalination with faster salt removal kinetics.

### Example 4—Removal Efficiencies (%) at Various Concentrations of TFA (C2) and PFPrA (C3)

In wastewater or natural water sources, PFAS exists at dilute concentrations, with salt concentrations thousands of times higher, thus raising the difficulty of PFAS removal. To assess the capability of removing ultra-short-chain PFAS with respect to the range of concentration ratios between PFAS and competing salt, redox-polymer ED was performed at varying concentrations of TFA and PFPrA (from 1 μM to 1 mM), which were 10-10,000 times lower compared to NaCl. The concentration ranges of ultra-short-chain PFAS investigated in this experiment are close to those found in real source water, such as wastewater treatment plants (1.8 μM TFA) and river water (1.21 μM TFA).

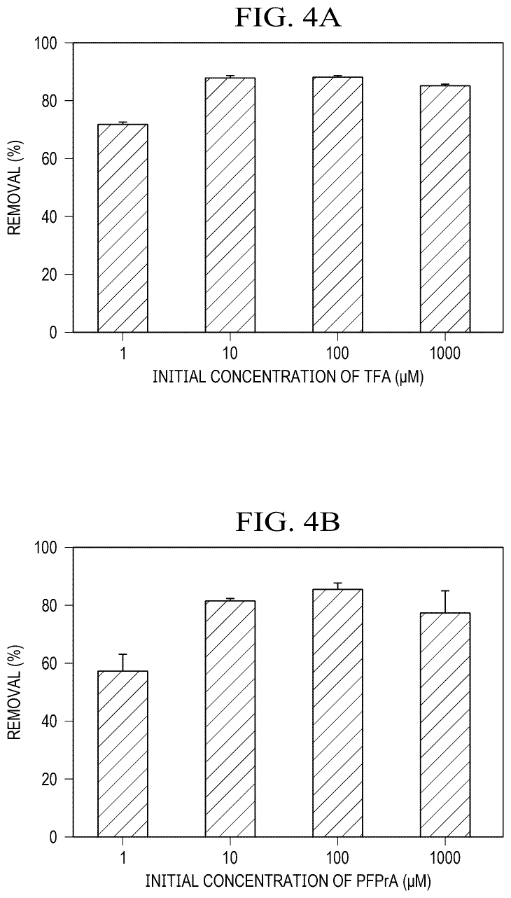

Referring to FIGS. 4A and 4B, both TFA (C2) and PFPrA (C3) showed similar trends in PFAS removal across varying concentrations, demonstrating a rapid increase in removal efficiencies from 70% to 89% for TFA and from 57% to 86% for PFPrA as the initial PFAS concentration increases from 1 μM to 100 μM. The enhanced removal % is primarily due to the increased availability of PFAS ions compared to chloride (Cl⁻) as the concentration ratio between PFAS and Cl⁻changes from 1:10,000 (1 μM:10 mM) to 1:100 (100 μM:10 mM). Based on the feed channel concentration changes within 7 hours, it is believed that a longer operating time would facilitate further removal of both TFA and PFPrA at high PFAS concentrations.

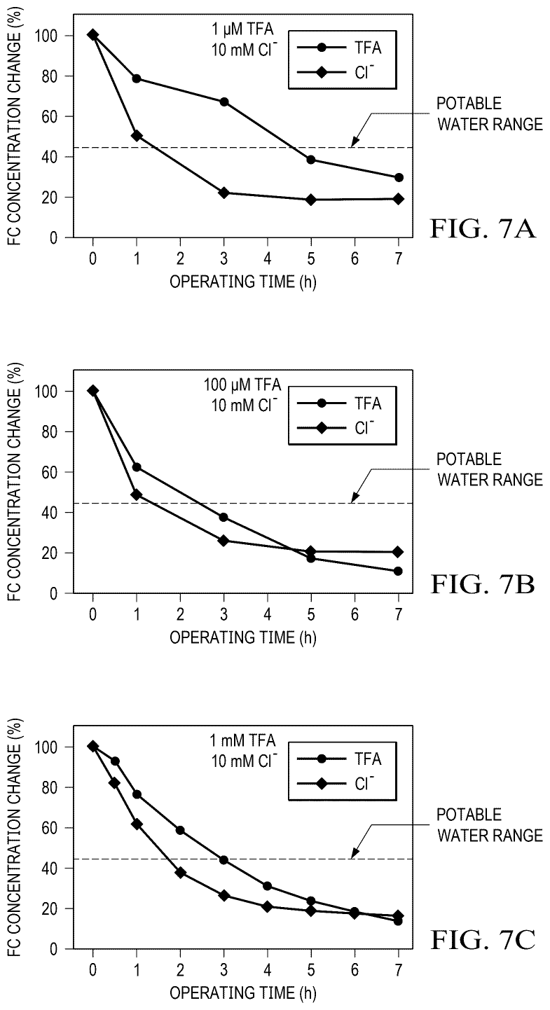

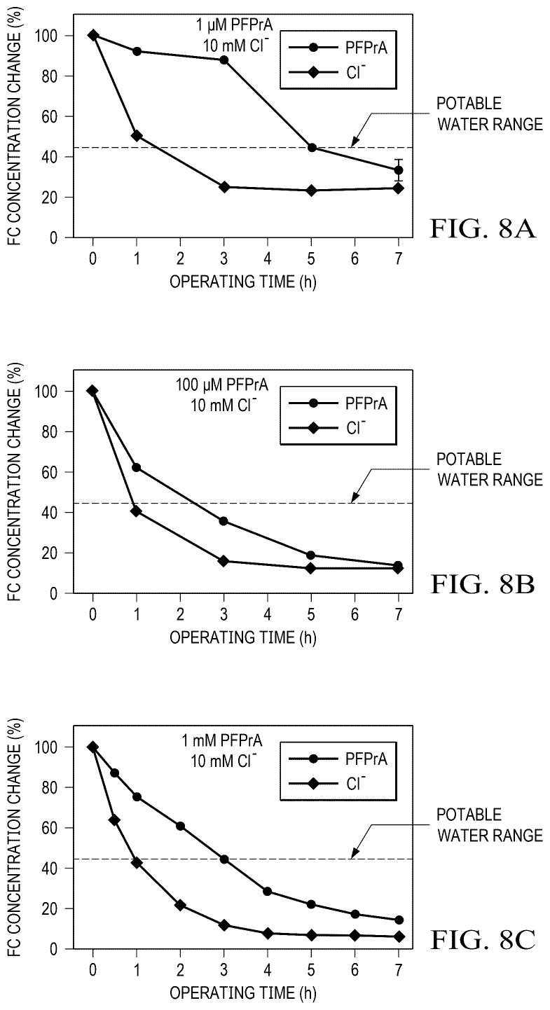

Referring to FIGS. 7A-7C and 8A-8C, desalination was also accomplished to the level required to meet potable water standards within 1.5 hours with an average Cl⁻ flux of 33.2 mmol/m²/h and 38.0 mmol/m²/h in the presence of TFA and PFPrA, respectively. Regardless of the PFAS to Cl⁻ concentration ratio, salt concentration reached equilibrium within 3 hours of operation, achieving an average salt removal of 86% for all PFAS ratios. On the other hand, throughout the 7-hour experiments, redox-polymer ED continuously removed both TFA and PFPrA, retaining 43% and 58% of the initial TFA and PFPrA removal rate, respectively, by the end of the operation. The remarkable TFA and PFPrA removal, along with the consistent desalination performance, underlines the capability of the redox-polymer ED system with SEMs for the simultaneous removal of ultra-short-chain PFAS and salt. The results prove that the redox-polymer ED system can treat ultra-short-chain PFAS within a concentration range typically observed in actual source water, where salts were present at level 10-10,000 times higher than the target PFAS.

A significant benefit of simultaneous PFAS removal with desalination using the redox-polymer ED system is the consistent energy consumption of 0.270-0.340 kJ/mmol_{NaCl+PFAS}, regardless of PFAS concentrations. The mechanism of both PFAS removal and desalination is based on the ion migration to uphold the charge balance of the RC during a reversible redox reaction of the redox polymer. Given that the change in the overall ionic resistance is negligible with respect to the PFAS concentration, both the total energy consumption and overall desalination performance would not be influenced by the concentration of PFAS in the presence of chloride as a predominant species in the FC. Only 0.0075%, 0.11%, 1.1%, and 7.4% of the total energy consumption is allocated to remove 1 μM, 10 μM, 100 μM, and 1 mM ultra-short-chain PFAS, respectively. Consequently, the redox-polymer ED system is more suitable for calculating the overall energy consumption required for both PFAS removal and desalination (kJ/mmol_{NaCl+PFAS}) rather than calculating energy consumption for PFAS removal (kJ/mmol_{PFAS}).

### Example 5—Single-Process of Ultra-Short to Long-Chain PFAS Removal

1. Performance Comparison of PFAS Removal and Desalination between Redox-Polymer ED and Conventional ED with SEMs

To compare single-step removal of a wide range of PFAS using a redox-polymer ED system and a conventional ED system without redox polymer in the RC, 10 μM of PFPrA (C3), PFBA (C4), PFHxA (C6), and PFOA (C8) were mixed as a representative of ultra-short-, short-, and long-chain PFAS, respectively, along with 10 mM NaCl for desalination. Prior to the comparison, the operating voltage of the conventional ED system was determined through the linear sweep voltammetry, where the current matched that of the oxidation reaction of 30 mM P(TMA₃₃-TMPMA₁₇-METAC₅₀) at 1.0 V.

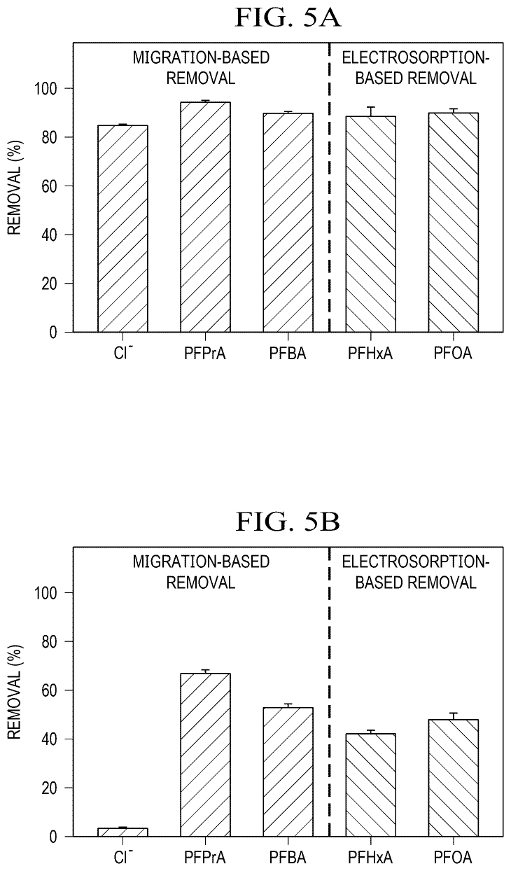

Referring to FIGS. 5A and 5B, the redox-polymer ED system effectively treated a wide range of PFAS and exhibited enhanced removal performance (FIG. 5A) in comparison to conventional ED systems using water-splitting reactions for ion removal (FIG. 5B). Since both redox-polymer ED and conventional ED used SEMs, they can treat a diverse range of PFAS without any membrane fouling. In the redox-polymer ED system, the direction of ion removal can be controlled from the FC to the AC effectively, by taking advantage of the effective retention of the redox-polymer by SEMs. Consequently, approximately 90% of PFAS (PFPrA (94%), PFBA (90%), PFHxA (89%), and PFOA (90%)) were removed, regardless of their chain lengths, in addition to an 85% removal of chloride. On the other hand, water-splitting reaction in the conventional ED system generates protons and hydroxides, which can also migrate through SEMs in the opposite direction of the intended ion removal. As a result, both salt and PFAS removal performance decreased to 4% and 43-67%, respectively in comparison to the redox-polymer ED system. It is believed that the limited salt removal in the conventional ED with SEMs could be attributed to the presence of a higher concentration of ions in the RC than in the FC, leading to a reduction in the diffusion effect and promoting the migration of protons and hydroxides.

### 2. Examination of the Mechanism of PFAS Removal in the Redox-Polymer ED System

Depending on the PFAS chain lengths, the removal mechanism of PFAS in the redox-polymer ED varies between electrosorption and migration.

### (1) Electrosorption Studies

To probe the underlying removal mechanism, electrosorption studies were first conducted with an equimolar mixture of 1 mM TFA, PFPrA, PFBA, PFHxA, and PFOA in solution along with 10 mM NaCl. The electrosorption experiment was performed in an H-cell using 3.0 ×3.0 cm² activated carbon clothes (with an average weight of 200-250 mg) on both anode and cathode electrodes. The H-cell system was operated at a voltage of 1.0 V (two-electrode system) for 1 hour to achieve equilibrium electrosorption values. For the anodic electrolyte (working electrode side), a solution of 15 mL containing 1 mM each of TFA, PFPrA, PFBA, PFHxA, and PFOA, along with 10 mM NaCl, was prepared, while the cathodic electrolyte consisted of 20 mM NaCl. The initial and final solutions were collected to analyze PFAS electrosorption using the LC-MS.

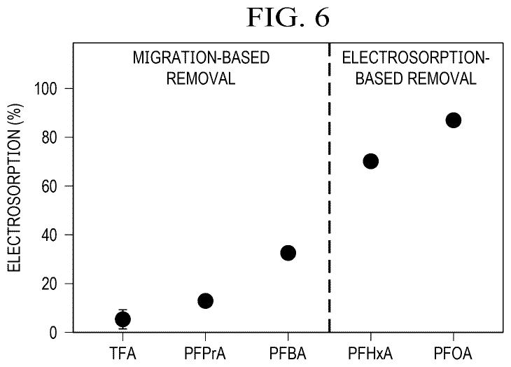

Referring to FIG. 6, in the electrosorption test, a significant concentration decrease was observed for PFAS with chain lengths equal to or greater than C6, showing 71% and 88% concentration decreases in PFHxA (C6) and PFOA (C8), respectively. With a decrease in the chain lengths from C4 to C2, PFAS exhibited weaker binding affinity to the carbon electrodes, leading to a concentration reduction of 33%, 13%, and 5% for PFBA (4C), PFPrA (3C), and TFA (2C), respectively. The results showcase that the electrostatic and hydrophobic interactions with electrode effectively eliminate relatively long-chain PFAS, such as PFHxA and PFOA.

### (2) Ion Migration Studies

After 7-hour operation of the redox-polymer ED system, the distribution of chloride and various PFAS in different compartments of the system (e.g., FC, AC, RC, electrodes) was evaluated. To distinguish between migration and electrosorption mechanisms clearly, the initial concentration of PFAS was increased, and an equimolar concentration (2 mM) of chloride and PFAS were employed as a FC. Chloride and PFAS concentrations for each compartment were assessed using IC and LC-MS, respectively. The distribution of chloride and different chain lengths of PFAS in different components were analyzed based on the mass balance. Percent distribution was determined by dividing the concentrations in each component by the initial concentration in the FC.

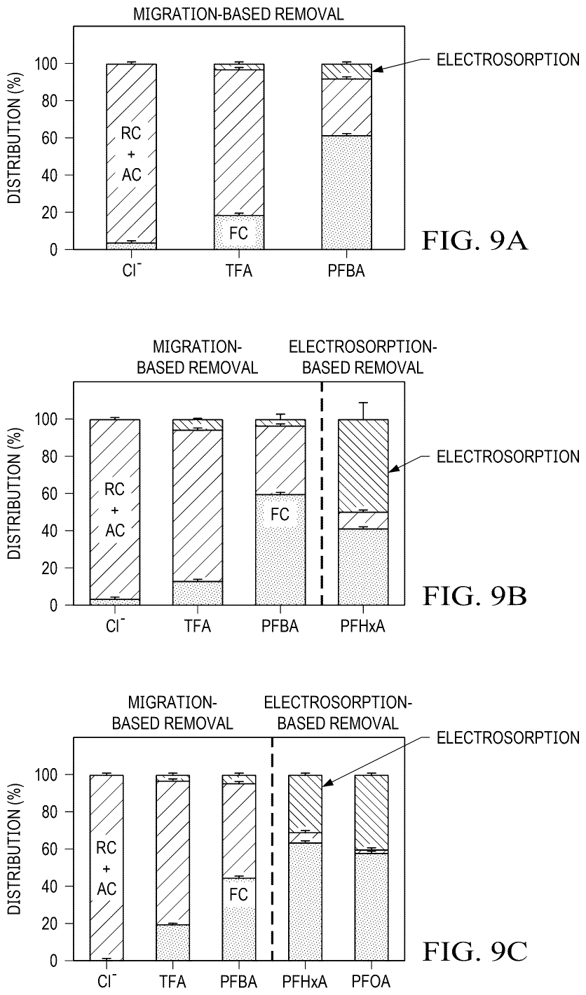

Referring to FIG. 9A, in the presence of TFA (C2) and PFBA (C4), over 80% of TFA (C2) was treated with minimal electrosorption, and less than 20% of treated PFBA (C4) was electrosorbed. Referring to FIGS. 9B and 9C, when PFHxA (C6) and/or PFOA (C8) were added to the feed solution, similar PFAS removal and even lower electrosorption were observed for TFA (C2) and PFBA (C4). The result highlights that PFAS with chain lengths ≤C4 is predominantly removed through migration from the FC to the AC and RC, while PFAS with chain lengths ≥C6 are treated via electrosorption on the positively charged first electrode. Furthermore, 99% of chloride was desalinated throughout the experiments, showing the exceptional desalination capability of the redox-polymer ED system.

Overall, it is shown that by leveraging electrosorption and both ion migration, the redox-polymer ED system may remove a wide variety of PFAS compounds in a single operation, effectively overcoming the conventional sequential PFAS treatment process. It is believed that the redox-polymer ED system can intensify the water remediation process, especially advantageous for mixed chain-length PFAS at high concentration levels, as its capacity is not limited by active materials, nor does it require high energy inputs such as pressure.

### Example 5—Coupling Redox-Polymer ED System with Electrochemical Oxidation System for Defluorination of PFAS

### 1. Redox-Polymer ED System for Real Wastewater Treatment

To evaluate the feasibility of the redox-polymer ED system for real wastewater treatment, the desalination on secondary wastewater simultaneously with the removal of ultra-short chain PFAS was performed. The secondary wastewater was obtained from the Illinois regional wastewater facility after primary treatment. 10 μM of TFA or PFPrA to 20 mL of the real wastewater samples were introduced as representative PFAS contaminants. The wastewater samples contained Cl⁻(16.85 mM), NO₃-(1.75 mM), SO₄²⁻(6.82 mM), and HPO₄²⁻(0.965 mM). The test was performed at 1.0 V for 24 hours, using 30 mM of TMA in P(TMA₃₃-co-TMPMA17-co-METAC50) as the electrolyte and ACC (3.0×3.0 cm²) on both anode and cathode electrodes.

In the wastewater, 82% of TFA and 84% of PFPrA were effectively treated. Over 65% of small anionic species (61% of Cl⁻, 44% of NO₃⁻, 88% of SO₄²⁻, and 50% of HPO₄²⁻) were desalinated from the wastewater). In particular, divalent species, such as SO₄²⁻ and HPO₄²⁻, exhibited more effective desalination than monovalent species. Although multiple electrochemical and pressure-driven studies have demonstrated selective separation of monovalent ions from multivalent species using functionalized SEMs (e.g., modified polyethersulfone and polyamide) with a MWCO of 200-800 Da, the approach described herein employs non-functionalized cellulose-based SEMs with a larger molecular weight cut-off of 1 kDa. Consequently, the membrane does not experience significant charge repulsion against multivalent ions. It is believed that ion mobility is primarily influenced by the valency of ions under an electric field, possibly due to stronger electrostatic attraction.

### 2. Up-Concentration Experiment

1 L containing 10 mM NaCl with either 10 μM of TFA (C2) or PFPrA (C3) was used as the FC solution, while 20 mL of 10 mM NaCl and 20 mL of 30 mM of TMA in P(TMA₃₃-co-TMPMA₁₇-co-METAC₅₀) were used as the AC and RC solutions, respectively. The experiments were conducted for three days to investigate long-term stability, as well as the up-concentration capability of the redox polymer ED system. In a long-term operation, the recycled polymer was utilized to evaluate the reusability and stability of P(TMA₃₃-co-TMPMA₁₇-co-METAC₅₀). The polymers used in previous experiments (primarily for FIGS. 4A, 4B and 5A) were utilized to exclusively recover them, and subsequently, their chemical and electrochemical properties were characterized. GPC and CV results confirmed that there was no significant reduction in polymer chain lengths or changes in electrochemical properties, while FTIR spectrum verified the absence of PFAS in the recycled polymers. The recyclability of polymers may offer additional economic benefits in the redox-polymer ED system, along with the cost-effective polymer SEMs and polymer synthesis.

Over 72 hours of operation, the redox-polymer ED system exhibited consistent up-concentration performance for TFA (C2) or PFPrA (C3), achieving 2.6- and 2.7-fold up-concentration in the AC compared to the feed solution. In the initial 24-hour operation, chloride tended to enrich more rapidly than PFAS. However, over an extended period, chloride reached an equilibrium in the AC and exhibited 2-fold enrichment compared to the initial feed solution. This up-concentration experiment provides insights into a single process for PFAS treatment using the redox-polymer ED, which includes desalination and PFAS removal from the feed solution and its up-concentration. Additionally, stable long-term operation highlights the reusability and stability of redox copolymers.

### 3. Defluorination System

Following redox-polymer ED, treated PFAS can undergo defluorination in two different scenarios: (i) shorter-chain PFAS present in the AC solution (PFAS with chain lengths ≤C4) and (ii) longer-chain PFAS electrosorbed onto the electrode (PFAS with chain lengths ≥C6).

As a proof-of-concept, (i) the defluorination of 1 mM of TFA (C2) and PFPrA (C3) present in AC solution and (ii) the defluorination of electrosorbed PFHxA (C6) were demonstrated. In this study, electrochemical oxidation using a BDD anode was employed. The anode, cathode, and reference electrode were boron-doped diamond (BDD, 1.0 33 1.0 cm²), ACC (1.0×1.0 cm²), and Ag/AgCl, respectively. In the case of electrosorbed PFAS (e.g., PFHxA), electrosorption of the target PFAS in 1 mM PFAS and 20 mM NaCl was performed prior to the defluorination test at an operating potential of 1.0 V for 1 hour in a three-electrode cell with ACC (1.0×1.0 cm²), Pt wire, and Ag/AgCl as anode, cathode, and reference electrode, respectively. Subsequently, this ACC was utilized as a cathode in defluorination experiments to demonstrate the mineralization of electrosorbed PFAS. Fluoride, chloride, and perchlorate concentrations were measured by the IC. Defluorination (%) was subsequently determined by assessing the mass balance of initial PFAS concentrations in solution (for TFA and PFPrA) or electrosorbed (for PFHxA), whereas the remaining chloride (%) and perchlorate production (%) were calculated based on the starting NaCl concentrations (20 mM).

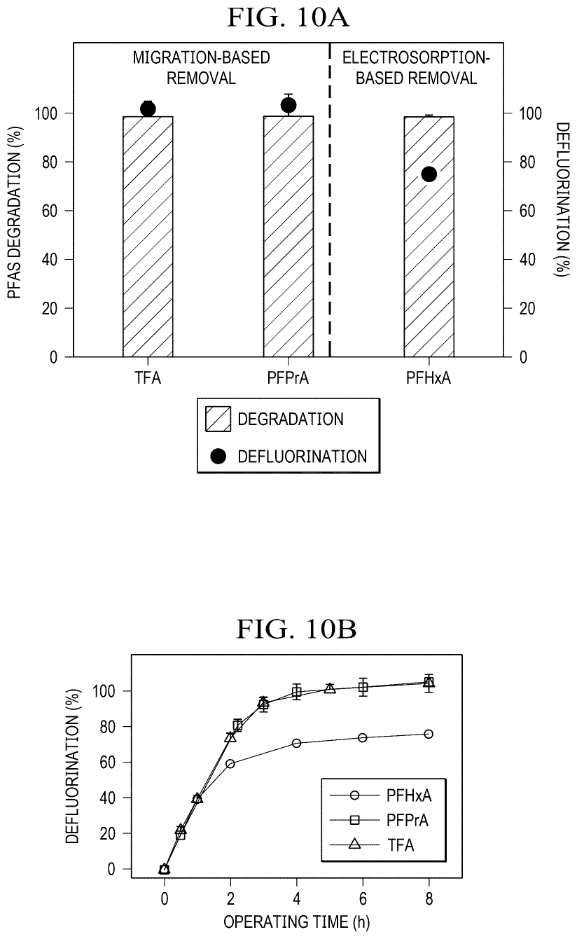

Referring to FIGS. 10A and 10B, TFA (C2) and PFPrA (C3) showed complete PFAS degradation and defluorination in 6 hours, while PFHxA (C6) exhibited complete degradation, as well as 76% defluorination in 8 hours. Electrosorbed PFHxA (C6) undergoes two steps of the defluorination process: desorption from the ACC followed by defluorination. The defluorination involves multiple degradation processes, which involve direct electron transfers from PFAS to the BDD surface, and subsequent indirect oxidation of PFAS by hydroxyl radicals generated by the BDD. Consequently, the mineralization of PFHxA (C6) requires a longer defluorination period compared to TFA and PFPrA, which are more hydrophilic and do not require a desorption step. Due to high oxidation power, BDD oxidized chloride into perchlorate as a disinfection by-product. Over 80% of chloride (20 mM) present in the defluorination test was converted into perchlorate.

Considering the health risks associated with ClO₄₋, reducing chlorine oxidation is essential to improve defluorination efficiency and address a pressing topic in drinking water safety. In this regard, the redox-polymer ED system can be integrated with various PFAS degradation systems to address the perchlorate issue, including photoelectrochemical oxidation, plasma-based techniques, and ultrasonic irradiation. Additionally, surface modification of anode and optimizing oxidation conditions (e.g., adding hydrogen peroxide) can help the electrochemical oxidation process suppress byproduct generation.

In an industrial operation, the redox-polymer ED can be upscaled through membrane and electrode stacking and the utilization of a higher concentration of redox-polymers. After redox-polymer ED operation, the anodic ACC, where the electrosorption of long-chain PFAS occurs, can serve as a cathode for electrochemical defluorination. The AC of the redox-polymer ED system, where ultra-short-/short-chain PFAS is up-concentrated, can serve as an electrolyte for defluorination, effectively integrating two defluorination scenarios into a unified process.

In sum, the technology described in this disclosure provides an electrochemical strategy to remove PFAS from ultra-short to long-chain PFAS within a single process. A redox-polymer ED system in this disclosure leverages a water-soluble redox polymer with inexpensive SEMs, facilitating the treatment of varied chain lengths of PFAS without membrane fouling. The approach in this disclosure combines both ion migration by electrodialysis (for PFAS with chain lengths ≤C4) and electrosorption strategies (for PFAS with chain lengths ≥C6) to eliminate, in some examples, at least90% of ultra-short-, short-chain, and long-chain PFAS. At the same time, continuous desalination of the source water down to potable water level can be achieved. The redox-polymer ED may exhibit remarkable PFAS removal in real source water scenarios, including from matrices with 10,000 times higher salt concentrations, as well as secondary effluents from wastewater. Additionally, the removed PFAS may be mineralized with a defluorination performance between 76-100% by electrochemical oxidation, highlighting the viability of integrating the separation step with a reactive degradation process.

A first aspect relates to a method for removing per-and polyfluoroalkyl substances (PFAS) from a feed solution, the method comprising: flowing a feed solution comprising PFAS of varying chain lengths through a feed channel; applying a voltage to a first electrode and a second electrode in a redox channel separated from the feed channel by a first SEM, the first electrode becoming positively charged and the second electrode becoming negatively charged, wherein the PFAS in the feed solution transfer through the first SEM into the redox channel toward the first electrode; and separating PFAS based on chain length, wherein long-chain PFAS adhere to the first electrode through hydrophobic and electrostatic interactions, and short-chain to ultra-short chain PFAS migrate toward the second electrode in the redox channel and pass through a second SEM into an accumulating channel, thereby creating a PFAS-concentrated solution in the accumulating channel.

A second aspect relates to the method of the first aspect, wherein the SEM comprises a NF membrane.

A third aspect relates to the method of the first or second aspect, wherein the SEM comprises a NF membrane with a molecular weight cut-off of greater than about 800 Da.

A fourth aspect relates to the method of any preceding aspect, wherein the ultra-short-chain PFAS comprises trifluoroacetic acid (TFA) or perfluoropropanoic acid (PFPrA); the short-chain PFAS comprises perfluorobutanoic acid (PFBA); and the long-chain PFAS comprises perfluorohexanoic acid (PFHxA) or perfluorooctanoic acid (PFOA).

A fifth aspect relates to the method of any preceding aspect, further comprising flowing the PFAS-concentrated solution into an electrochemical oxidation system comprising two electrodes that are oppositely charged during operation.

A sixth aspect relates to the method of any preceding aspect, further comprising obtaining, after separating PFAS based on chain length, the first electrode with adhered PFAS; placing the first electrode with adhered PFAS into an electrochemical oxidation system; and applying a negative voltage to the first electrode to facilitate release of the adhered PFAS.

A seventh aspect relates to the method of any preceding aspect, further comprising: flowing the PFAS-concentrated solution from the accumulating channel into an electrochemical oxidation system comprising the first electrode with adhered PFAS and another electrode, wherein the adhered PFAS comprises the long-chain PFAS; and applying a negative voltage to the first electrode and a positive voltage to the other electrode, wherein the adhered PFAS is released from the first electrode, and the long-chain and short-chain to ultra-short chain PFAS in the solution are defluorinated.

An eighth aspect relates to the method of any preceding aspect, wherein the electrode that is positively charged during operation is BDD electrode.

A ninth aspect relates to the method of any preceding aspect, wherein a water-soluble redox polymer circulates through the redox channel during application of the voltage, repetitively oxidizing near the first electrode and reducing near the second electrode; and the water-soluble redox polymer comprises a redox-active moiety and a water-soluble moiety.

A tenth aspect relates to the method of any preceding aspect, wherein the redox-active moiety comprises 2,2,6,6-tetramethyl-1-piperidinyloxymethacrylate (TMA).

An eleventh aspect relates to the method of any preceding aspect, wherein a molar ratio of a redox-active moiety within the water-soluble redox polymer is greater than about 20%.

A twelfth aspect relates to the method of any preceding aspect, wherein the water-soluble redox polymer comprises a terpolymer.

A thirteenth aspect relates to the method of any preceding aspect, wherein the terpolymer is poly(2,2,6,6-tetramethyl-1-piperidinyloxymethacrylate-co-2,2,6,6-tetramethyl-1-piperidylmethacrylate-co-[2-(methacryloyloxy)ethyl]trimethyl-ammonium chloride) P(TMA-co-TMPMA-co-METAC).

A fourteenth aspect relates to the method of any preceding aspect, wherein an average molecular weight (Mn) of the redox polymer is in a range from about 1,000 g/mol to about 5,000 g/mol.

A fifteenth aspect relates to the method of any preceding aspect, wherein the first electrode and the second electrode in the redox channel comprise activated carbon cloth electrodes.

A sixteenth aspect relates to the method of any preceding aspect, wherein the method further comprising: desalinating the feed solution to a potable water level during PFAS removal process.

A seventeenth aspect relates to the method of any preceding aspect, wherein the method eliminates greater than about 80% of PFAS from the feed solution.

An eighteenth aspect relates to a redox-polymer ED system for removing PFAS from a feed solution, the system comprising: a first electrode; a second electrode positioned in opposition to the first electrode; a first SEM and a second SEM positioned between the first and second electrodes; a cation exchange membrane (CEM) positioned between the first and second SEMs, the CEM defining a feed channel and an accumulating channel between the SEMs; and a redox channel containing the first and second electrodes and being separated from feed and/or accumulating channels by the pair of SEMs, wherein the feed channel is configured for flow of the feed solution comprising PFAS of varying chain lengths, wherein the redox channel is configured for flow of a redox solution comprising a redox polymer, wherein the first electrode is configured for electrosorption of long-chain FPAS upon application of a positive voltage, and wherein the accumulating channel is configured to collect and concentrate short-chain to ultra-short chain PFAS removed from the feed solution.

A nineteenth aspect relates to the redox polymer ED system of the eighteenth aspect, wherein the redox polymer comprises P(TMA-co-TMPMA-co-METAC).

A twentieth aspect relates to a system for defluorination of PFAS, comprising: the redox-polymer ED system of the eighteenth or nineteenth aspect; and an electrochemical oxidation system configured to receive a concentrated solution of short-chain to ultra-short chain PFAS in the accumulating channel of the redox-polymer ED system, wherein the electrochemical oxidation system comprises two electrodes, one of the two electrodes being the first electrode from the redox-polymer ED system obtained after electrosorption of the long-chain PFAS.

Unless otherwise explained, all technical and scientific terms used herein have the same meaning as commonly understood by one of ordinary skill in the art to which a disclosed disclosure belongs. The singular terms “a,” “an,” and “the” include plural referents unless context clearly indicates otherwise. Similarly, the word “or” is intended to include “and” unless the context clearly indicates otherwise. “Comprising” means “including”; hence, “comprising A or B” means “including A” or “including B” or “including A and B. ” All references cited herein are incorporated by reference.

The disclosure may be further understood by the following non-limiting examples. All references cited herein are hereby incorporated by reference to the extent not inconsistent with the disclosure herewith. Although the description herein contains many specificities, these should not be construed as limiting the scope of the disclosure but as merely providing illustrations of some of the presently preferred embodiments of the disclosure. For example, thus the scope of the disclosure should be determined by the appended aspects and their equivalents, rather than by the examples given.

While the present disclosure can take many different forms, for the purpose of promoting an understanding of the principles of the disclosure, reference will now be made to the embodiments illustrated in the drawings and specific language will be used to describe the same. It will nevertheless be understood that no limitation of the scope of the disclosure is thereby intended. Any alterations and further modifications of the described embodiments, and any further applications of the principles of the disclosure as described herein are contemplated as would normally occur to one skilled in the art to which the disclosure relates.

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the disclosure. Thus, it should be understood that although the present disclosure has been specifically disclosed by preferred embodiments, exemplary embodiments and optional features, modification and variation of the concepts herein disclosed may be resorted to by those skilled in the art, and that such modifications and variations are considered to be within the scope of this disclosure as defined by the appended aspects. The specific embodiments provided herein are examples of useful embodiments of the present disclosure and it will be apparent to one skilled in the art that the present disclosure may be carried out using a large number of variations of the devices, device components, methods steps set forth in the present description. As will be obvious to one of skill in the art, methods and devices useful for the present methods can include a large number of optional composition and processing elements and steps.

When a group of substituents is disclosed herein, it is understood that all individual members of that group and all subgroups, including any isomers, enantiomers, and diastereomers of the group members, are disclosed separately.

When a Markush group or other grouping is used herein, all individual members of the group and all combinations and subcombinations possible of the group are intended to be individually included in the disclosure. When a compound is described herein such that a particular isomer, enantiomer or diastereomer of the compound is not specified, for example, in a formula or in a chemical name, that description is intended to include each isomers and enantiomer of the compound described individual or in any combination. Additionally, unless otherwise specified, all isotopic variants of compounds disclosed herein are intended to be encompassed by the disclosure. For example, it will be understood that any one or more hydrogens in a molecule disclosed can be replaced with deuterium or tritium. Isotopic variants of a molecule are generally useful as standards in assays for the molecule and in chemical and biological research related to the molecule or its use. Methods for making such isotopic variants are known in the art. Specific names of compounds are intended to be exemplary, as it is known that one of ordinary skill in the art can name the same compounds differently.

Every formulation or combination of components described or exemplified herein can be used to practice the disclosure, unless otherwise stated.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the aspects herein.

All patents and publications mentioned in the specification are indicative of the levels of skill of those skilled in the art to which the disclosure pertains. References cited herein are incorporated by reference herein in their entirety to indicate the state of the art as of their publication or filing date and it is intended that this information can be employed herein, if needed, to exclude specific embodiments that are in the prior art. For example, when compositions of matter are disclosed, it should be understood that compounds known and available in the art prior to Applicant's disclosure, including compounds for which an enabling disclosure is provided in the references cited herein, are not intended to be included in the composition of matter aspects herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the aspect element. As used herein, “consisting essentially of” does not exclude materials or steps that do not materially affect the basic and novel characteristics of the aspect. In each instance herein any of the terms “comprising”, “consisting essentially of” and “consisting of” may be replaced with either of the other two terms. The disclosure illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the disclosure without resort to undue experimentation. All art-known functional equivalents, of any such materials and methods are intended to be included in this disclosure. The terms and expressions which have been employed are used as terms of description and not of limitation, and there is no intention that in the use of such terms and expressions of excluding any equivalents of the features shown and described or portions thereof, but it is recognized that various modifications are possible within the scope of the disclosure. Thus, it should be understood that although the present disclosure has been specifically disclosed by preferred embodiments and optional features, modification and variation of the concepts herein disclosed may be resorted to by those skilled in the art, and that such modifications and variations are considered to be within the scope of this disclosure as defined by the appended aspects.

Although the present disclosure has been described with reference to certain embodiments thereof, other embodiments are possible without departing from the present disclosure. The spirit and scope of the appended aspects should not be limited, therefore, to the description of the preferred embodiments contained herein. All embodiments that come within the meaning of the aspects, either literally or by equivalence, are intended to be embraced therein. Furthermore, the advantages described above are not necessarily the only advantages of the disclosure, and it is not necessarily expected that all of the described advantages will be achieved with every embodiment of the disclosure.ss

1. A method for removing per-and polyfluoroalkyl substances (PFAS) from a feed solution, the method comprising:
flowing a feed solution comprising PFAS of varying chain lengths through a feed channel;
applying a voltage to a first electrode and a second electrode in a redox channel separated from the feed channel by a first size exclusion membrane (SEM), the first electrode becoming positively charged and the second electrode becoming negatively charged, wherein the PFAS in the feed solution transfer through the first SEM into the redox channel toward the first electrode; and
separating PFAS based on chain length, wherein
long-chain PFAS adhere to the first electrode through hydrophobic and electrostatic interactions, and
short-chain to ultra-short chain PFAS migrate toward the second electrode in the redox channel and pass through a second SEM into an accumulating channel, thereby creating a PFAS-concentrated solution in the accumulating channel.

2. The method of claim 1, wherein the SEM comprises a nanofiltration (NF) membrane.

3. The method of claim 2, wherein the SEM comprises a NF membrane with a molecular weight cut-off of greater than about 800 Da.

4. The method of claim 1, wherein
the ultra-short-chain PFAS comprises trifluoroacetic acid (TFA) or perfluoropropanoic acid (PFPrA);
the short-chain PFAS comprises perfluorobutanoic acid (PFBA); and
the long-chain PFAS comprises perfluorohexanoic acid (PFHxA) or perfluorooctanoic acid (PFOA).

5. The method of claim 1, further comprising:
flowing the PFAS-concentrated solution into an electrochemical oxidation system comprising two electrodes that are oppositely charged during operation.

6. The method of claim 1, further comprising:
obtaining, after separating PFAS based on chain length, the first electrode with adhered PFAS;
placing the first electrode with adhered PFAS into an electrochemical oxidation system; and
applying a negative voltage to the first electrode to facilitate release of the adhered PFAS.

7. The method of claim 1, further comprising:
flowing the PFAS-concentrated solution from the accumulating channel into an electrochemical oxidation system comprising the first electrode with adhered PFAS and another electrode, wherein the adhered PFAS comprises the long-chain PFAS; and
applying a negative voltage to the first electrode and a positive voltage to the other electrode, wherein the adhered PFAS is released from the first electrode, and the long-chain and short-chain to ultra-short chain PFAS in the solution are defluorinated.

8. The method of claim 5, wherein the electrode that is positively charged during operation is boron-doped diamond (BDD) electrode.

9. The method of claim 1, wherein a water-soluble redox polymer circulates through the redox channel during application of the voltage, repetitively oxidizing near the first electrode and reducing near the second electrode; and
the water-soluble redox polymer comprises a redox-active moiety and a water-soluble moiety.

10. The method of claim 9, wherein the redox-active moiety comprises 2,2,6,6-tetramethyl-1-piperidinyloxymethacrylate (TMA).

11. The method of claim 9, wherein a molar ratio of a redox-active moiety within the water-soluble redox polymer is greater than about 20%.

12. The method of claim 6, wherein the water-soluble redox polymer comprises a terpolymer.

13. The method of claim 10, wherein the terpolymer is poly(2,2,6,6-tetramethyl-1-piperidinyloxymethacrylate-co-2,2,6,6-tetramethyl-1-piperidylmethacrylate-co-[2-(methacryloyloxy)ethyl]trimethyl-ammonium chloride) P(TMA-co-TMPMA-co-METAC).

14. The method of claim 6, wherein an average molecular weight (Mn) of the redox polymer is in a range from about 1,000 g/mol to about 5,000 g/mol.

15. The method of claim 1, wherein the first electrode and the second electrode in the redox channel comprise activated carbon cloth electrodes.

16. The method of claim 1, the method further comprising:
desalinating the feed solution to a potable water level during PFAS removal process.

17. The method of claim 1, wherein the method eliminates greater than about 80% of PFAS from the feed solution.

18. A redox-polymer ED system for removing PFAS from a feed solution, the system comprising:
a first electrode;
a second electrode positioned in opposition to the first electrode;
a first SEM and a second SEM positioned between the first and second electrodes;
a cation exchange membrane (CEM) positioned between the first and second SEMs, the CEM defining a feed channel and an accumulating channel between the SEMs; and
a redox channel containing the first and second electrodes and being separated from feed and/or accumulating channels by the pair of SEMs,
wherein the feed channel is configured for flow of the feed solution comprising PFAS of varying chain lengths,
wherein the redox channel is configured for flow of a redox solution comprising a redox polymer,
wherein the first electrode is configured for electrosorption of long-chain FPAS upon application of a positive voltage, and
wherein the accumulating channel is configured to collect and concentrate short-chain to ultra-short chain PFAS removed from the feed solution.

19. The redox-polymer ED system of claim 18, wherein the redox polymer comprises P(TMA-co-TMPMA-co-METAC).

20. A system for defluorination of PFAS, comprising:
the redox-polymer ED system of claim 18; and
an electrochemical oxidation system configured to receive a concentrated solution of short-chain to ultra-short chain PFAS in the accumulating channel of the redox-polymer ED system,
wherein the electrochemical oxidation system comprises two electrodes, one of the two electrodes being the first electrode from the redox-polymer ED system obtained after electrosorption of the long-chain PFAS.
